(19) United States
(12) Patent Application Publication
(10) Pub. No.: US 2025/0083453 A1
(43) Pub. Date: Mar. 13, 2025

(54) EJECTION AMOUNT UPPER LIMIT VALUE DETERMINATION METHOD AND PRINTING DEVICE

(71) Applicant: SEIKO EPSON CORPORATION, Tokyo (JP)

(72) Inventor: Yoshio OKUMURA, Matsumoto (JP)

(21) Appl. No.: 18/826,380

(22) Filed: Sep. 6, 2024

(30) Foreign Application Priority Data
Sep. 8, 2023 (JP) 2023-14507

(51) Int. Cl. B41J 2/21; G06K 15/02

(52) U.S. Cl. CPC B41J 2/2121; B41J 2/2135; G06K 15/027; G06K 2215/101

(57) ABSTRACT

In a test pattern formation step, a test pattern including a plurality of pattern arrays is formed. The pattern arrays include a plurality of patches having different per unit area ejection amounts with allowable liquid bleeding. In the upper limit value determination step, a provisional ejection amount upper limit value is determined for each pattern array based on the reading results of the plurality of patches and, when the difference between the maximum value and the minimum value of the plurality of provisional ejection amount upper limit values obtained for the plurality of pattern arrays is within an allowable range, either the minimum value or the maximum value is determined as the upper limit value and when the difference exceeds the allowable range, the upper limit value is determined so as to be larger than the minimum value and also smaller than the maximum value.

The present application is based on, and claims priority from JP Application Serial Number 2023-145707, filed Sep. 8, 2023, the disclosure of which is hereby incorporated by reference herein in its entirety.

### BACKGROUND

### 1. Technical Field

The disclosure relates to a technique for determining, with respect to a liquid ejected from a print head onto a medium, an upper limit value of a per unit area ejection amount with allowable liquid bleeding.

### 2. Related Art

As a printing device, there is known an inkjet printer that ejects ink droplets of a plurality of colors from a plurality of nozzles of a print head onto a print medium. When the ink ejection amount per unit area of the print medium is large, a phenomenon called “bleeding” may occur. Here, bleeding is a phenomenon in which ink spreads out to the surroundings. The degree of bleeding may vary depending on the type of print medium and the type of ink. Therefore, a test pattern including a plurality of pattern arrays having multiple patches with different ink ejection amounts is used to detect the degree of bleeding and to set an ink ejection amount upper limit value indicating an upper limit ink ejection amount at which bleeding is suppressed, and this is used for creating a color conversion look-up table (LUT). The printing device disclosed in JP-A-2018-126993 performs the above-described process for determining an ink ejection amount upper limit value so as to suppress phenomena other than “bleeding”.

The degree of bleeding occurring in each patch may vary greatly depending on the type of print medium or the like. When the variation in bleeding is large, if the ejection amount upper limit value is determined based on the ink ejection amount of the patch included in the pattern array that has the largest degree of bleeding, then the color gamut that can be expressed by the inkjet printer becomes narrower. When the color gamut is narrow, the coloration property of the printed image is greatly reduced, and the image quality of the printed image is lowered. In the case where the variation in bleeding is large, if the ejection amount upper limit value is determined based on the ink ejection amount of the patch included in the pattern array that has the smallest degree of bleeding, the degree of bleeding may become excessively large. If the degree of bleeding becomes too large, the image quality of the printed image drops.

### SUMMARY

The ejection amount upper limit value determination method of the present disclosure is an ejection amount upper limit value determination method for determining, with respect to a liquid ejected from a print head to a medium, an upper limit value of a per unit area ejection amount with allowable liquid bleeding,
the liquid including a plurality of different color types,
the ejection amount upper limit value determination method including
a test pattern formation step of forming, on the medium, a test pattern including a plurality of pattern arrays, the pattern arrays including a plurality of patches having different ejection amounts and each patch including a bleeding detection region and a background region having a color different from that of the bleeding detection region and
an upper limit value determination step of acquiring reading results of the plurality of patches included in the pattern arrays and determining the upper limit value based on the reading results of the plurality of patches, wherein
in the upper limit value determination step,
a provisional ejection amount upper limit value, which is a provisional value of the upper limit value, is determined for each of the pattern arrays based on reading results of the plurality of patches included in the pattern arrays,
when a difference between a maximum value of the plurality of the provisional ejection amount upper limit values obtained for the plurality of pattern arrays and a minimum value of the plurality of the provisional ejection amount upper limit values is within an allowable range, one of the minimum value and the maximum value is determined as the upper limit value, and
when the difference exceeds the allowable range, the upper limit value is determined to be greater than the minimum value and also less than the maximum value.

The printing device of the present disclosure includes
a print head that ejects a plurality of types of liquids having different colors onto a medium;
a control section configured to control the formation of a test pattern on the medium, the test pattern including a plurality of pattern arrays, the pattern arrays each including a plurality of patches having different per unit area ejection amounts with allowable liquid bleeding for the liquid, each patch of the pattern arrays including a bleeding detection region and a background region having a color different from that of the bleeding detection region, acquire reading results of the plurality of patches included in the plurality of pattern arrays, and determine an upper limit value of the ejection amount based on the reading results of the plurality of patches; and
a reading section that reads the plurality of patches, wherein
the control section performs
a first process of determining a provisional ejection amount upper limit value, which is a provisional value of the upper limit value, for each of the pattern arrays based on reading results of the plurality of patches included in the pattern arrays,
a second process of, when a difference between a maximum value of the plurality of provisional ejection amount upper limit values obtained for the plurality of pattern arrays and a minimum value of the plurality of provisional ejection amount upper limit values is within an allowable range, determining one of the minimum value and the maximum value as the upper limit value, and
a third process of determining the upper limit value so as to be larger than the minimum value and also smaller than the maximum value when the difference exceeds the allowable range.

### BRIEF DESCRIPTION OF THE DRAWINGS

FIG. 1 is a block diagram schematically showing an example of the configuration of a printing device.

FIG. 2 is a diagram schematically showing an operation example of the printer.

FIG. 3 is a diagram schematically showing an example of a test pattern on a medium.

FIG. 4 is a diagram schematically showing an example of the ink ejection amount.

FIG. 5 is a diagram schematically showing an example of spreading occurring in a patch having a linear region used for bleeding amount detection.

FIG. 6 is a diagram schematically showing an example in which an ejection amount upper limit value Dt_final is determined when variation in a bleeding amount V1 is small.

FIG. 7 is a diagram schematically showing an example in which the ejection amount upper limit value Dt_final is determined when the variation in the bleeding amount V1 is large.

FIG. 8 is a flowchart schematically showing an example of an ink ejection amount upper limit value determination process.

FIG. 9 is a flowchart schematically showing an example of a printing process.

FIG. 10 is a diagram schematically showing a display example of an UI screen.

FIG. 11 is a diagram schematically showing an example of receiving a change of a determination threshold value in accordance with the ejection amount upper limit value.

FIG. 12 is a flowchart schematically showing an example of an ink ejection amount upper limit value determination process for determining an ejection amount upper limit value in units of individual colors.

### DESCRIPTION OF EMBODIMENTS

Embodiments of the present disclosure will be described below. Of course, the following embodiments are merely illustrative of the present disclosure, and not all of the features shown in the embodiments are essential for the disclosed solution.

### (1) Overview of Technology Included in the Present Disclosure

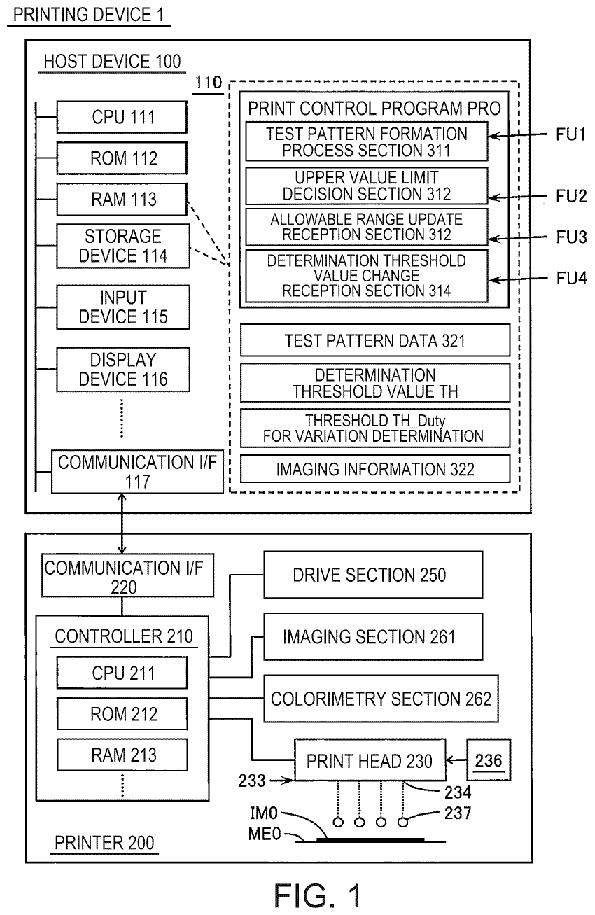

First, an overview of technology included in the present disclosure will be described with reference to the examples shown in FIGS. 1 to 12. Note that the drawings of the present application are diagrams that schematically illustrate examples, and the magnification ratios in the directions illustrated in these drawings may differ, and the respective drawings may not match. Of course, each element of the present technology is not limited to specific examples indicated by reference numerals. In the “Overview of technology included in the present disclosure”, terms in parentheses mean a supplementary explanation of the immediately preceding term.

In the present application, the numerical range “Min to Max” means the minimum value min or more and also the maximum value max or less.

### First Aspect

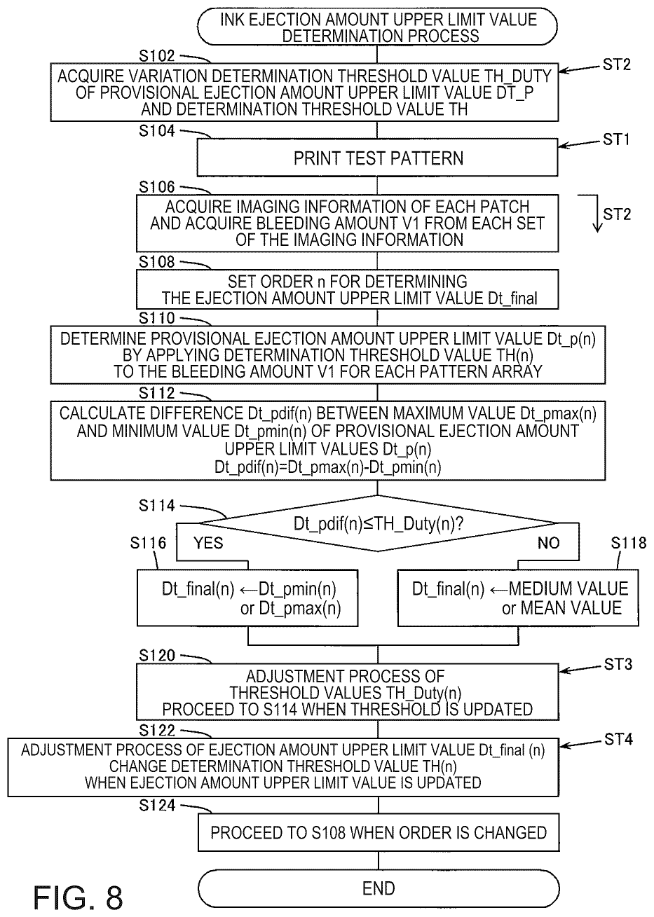

As illustrated in FIGS. 1, 8, and the like, an ejection amount upper limit value determination method according to an aspect of the present technology is an ejection amount upper limit value determination method for determining, with respect to a liquid (for example, ink 236) that was ejected from a print head 230 onto a medium ME0, an upper limit value Dt_final of a per unit area ejection amount with allowable bleeding of the liquid (236), and includes the following steps. Here, there are a plurality of types of different colors (for example, cyan, magenta, yellow, and black) of the liquid (236).

(a1) A test pattern formation step ST1 of forming, on the medium ME0, a test pattern 500 including a plurality of pattern arrays P0, each of the pattern arrays P0 including a plurality of patches 510 with different ejection amounts and each patch 510 including a bleeding detection region (for example, a linear region 532) and a background region (for example, a solid region 531) having a color different from that of the bleeding detection region (532).

(a2) An upper limit value determination step ST2 of acquiring reading results (for example, imaging information 322) of the plurality of patches 510 included in the pattern arrays P0, and determining the upper limit value Dt_final based on the reading results (322) of the plurality of patches 510.

The upper limit value determination step ST2 includes the following steps.

(b1) a step (for example, steps S106 to S110) of determining a provisional ejection amount upper limit value Dt_p, which is a provisional value of the upper limit value Dt_final, based on the reading results (322) of the plurality of patches 510 included in the pattern array P0 for each of the pattern arrays P0.

(b2) a step (for example, S116) of determining one of a minimum value Dt_pmin and a maximum value Dt_pmax to be the upper limit value Dt_final, when a difference Dt_pdif between a maximum value Dt_pmax of the plurality of provisional ejection amount upper limit values Dt_p, which were obtained for the plurality of pattern arrays P0, and a minimum value Dt_pmin of the plurality of provisional ejection amount upper limit values Dt_p, is within an allowable range (for example, a threshold value TH_Duty).

(b3) a step of (for example, S118), when the difference Dt_pdif exceeds the allowable range (TH_Duty), determining the upper limit value Dt_final so as to be larger than the minimum value Dt_pmin and also smaller than the maximum value Dt_pmax. When the difference Dt_pdif between the maximum value Dt_pmax of the provisional ejection amount upper limit value Dt_p and the minimum value Dt_pmin of the provisional ejection amount upper limit value Dt_p is within the allowable range (TH_Duty), then the variation in bleeding is small, and one of the minimum value Dt_pmin and the maximum value Dt_pmax is determined as the ejection amount upper limit value Dt_final. It should be noted that “bleeding variation” means a variation in the degree of bleeding in the bleeding detection regions of the plurality of patches 510 used for determining the upper limit value Dt_final. For example, when the upper limit value Dt_final is divided for each color order, “bleeding variation” means a variation in the degree of bleeding detected for each order. When the difference Dt_pdif between the maximum value Dt_pmax and the minimum value Dt_pmin exceeds the allowable range (TH_Duty), then the variation in bleeding is large, and the ejection amount upper limit value Dt_final is determined so as to be larger than the minimum value Dt_pmin and also smaller than the maximum value Dt_pmax. Since the ejection amount upper limit value Dt_final is larger than the minimum value Dt_pmin of the provisional ejection amount upper limit value Dt_p, excessive deterioration of the coloration property of the printed image IMO is suppressed. Since the ejection amount upper limit value Dt_final is smaller than the maximum value Dt_pmax of the provisional ejection amount upper limit value Dt_p, excessive bleeding of the liquid (236) is suppressed. Therefore, according to the above-described aspect, it is possible to provide an ejection amount upper limit value determination method capable of determining an ejection amount upper limit value that suppresses excessive deterioration of the coloration property or excessive bleeding of the liquid, even when there is a great deal of variation in bleeding.

Note that when the difference Dt_pdif between the maximum value Dt_pmax of the provisional ejection amount upper limit value Dt_p and the minimum value Dt_pmin of the provisional ejection amount upper limit value Dt_p is within the allowable range (TH_Duty), it is only necessary to set the minimum value Dt_pmin or the maximum value Dt_pmax to the ejection amount upper limit value Dt_final, so memory capacity required for this process can be reduced. Here, the reading results of the patches include an imaging result of patches by an imaging section such as a camera, reading results of patches by an image reading section such as a scanner, and the like.

When the difference exceeds the allowable range, this means that the difference is not within the allowable range. For example, it is assumed that a threshold value is used to realize case classification. In this case, if a value equal to or less than the threshold value corresponds to within the allowable range, then a value larger than the threshold value corresponds to exceeding the allowable range, and if a value smaller than the threshold value corresponds to within the allowable range, a value equal to or greater than the threshold value corresponds to exceeding the allowable range.

The foregoing remarks also apply to the following aspects.

### Second Aspect

As illustrated in FIG. 8 and the like, in the upper limit value determination step ST2, when the difference Dt_pdif exceeds the allowable range (TH_Duty), the mean of the plurality of provisional ejection amount upper limit values Dt_p may be determined as the upper limit value Dt_final.

In the above case, when the variation in bleeding is large, the ejection amount upper limit value Dt_final becomes as far as possible from both the minimum value Dt_pmin and the maximum value Dt_pmax of the provisional ejection amount upper limit value Dt_p. Therefore, the above-described aspect can provide a favorable example of suppressing excessive deterioration of the coloration property or excessive bleeding of the liquid, even when the variation in bleeding is large.

### Third Aspect

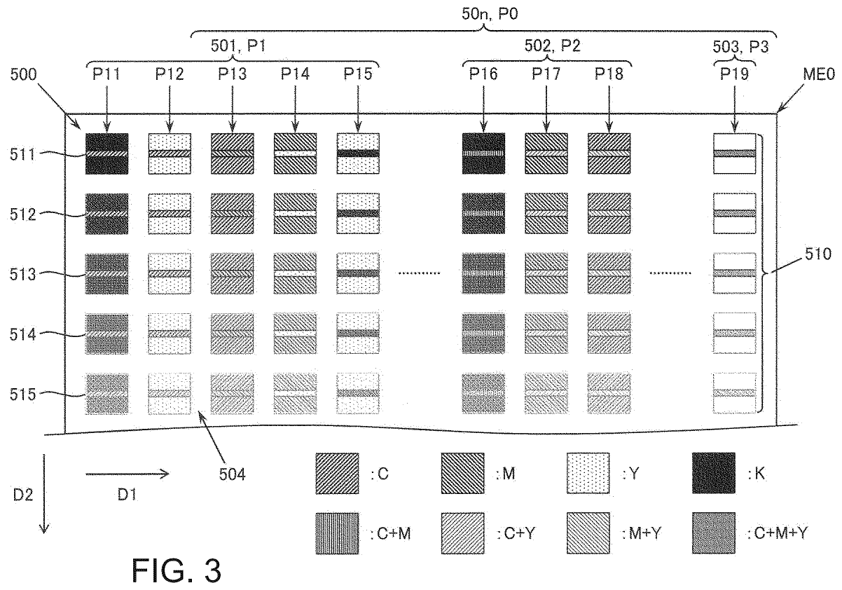

As illustrated in FIG. 3, the test pattern 500 may include an n-th color test pattern 50n wherein the bleeding detection region (532) of the patch 510 is an n-th color test pattern, where n is an integer that is 1 or more and also that is less than the number of types of the liquid (236). The provisional ejection amount upper limit value Dt_p may include the n-th color provisional ejection amount upper limit value Dt_p(n) for the n-th color test pattern 50n. The allowable range (TH_Duty) may include an n-th color allowable range (for example, a threshold value TH_Duty(n)) for the n-th color. The upper limit value determination step ST2, as illustrated in FIG. 8, may include the following steps.

(c1) a step (for example, steps S106 to S110) of determining, for each of the pattern arrays P0 in the n-th color test pattern 50n, the n-th color provisional ejection amount upper limit value Dt_p(n) based on the reading results (322) of the plurality of patches 510 included in the pattern arrays P0. (c2) a step (for example, step S116) of determining one of the n-th color minimum value Dt_pmin(n) and the n-th color maximum value Dt_pmax(n) to be the upper limit value Dt_final(n) for the n-th color when the difference Dt_pdif(n) between the n-th color maximum value Dt_pmax(n), which is the maximum value of the plurality of n-th color provisional ejection amount upper limit values Dt_p(n), and the n-th color minimum value Dt_pmin(n), which is the minimum value of the plurality of n-th color provisional ejection amount upper limit values Dt_p(n), is within the n-th color allowable range (TH_Duty(n)). (c3) a step (for example, step S118) of, when the difference Dt_pdif(n) between the n-th color maximum value Dt_pmax(n) and the n-th color minimum value Dt_pmin(n) exceeds the n-th color allowable range (TH_Duty(n)), determining the upper limit value (Dt_final(n)) for the n-th color so as to be larger than the n-th color minimum value Dt_pmin(n) and also smaller than the n-th color maximum value Dt_pmax(n). When the difference Dt_pdif(n) between the n-th color maximum value Dt_pmax(n) and the n-th color minimum value Dt_pmin(n) is within the n-th color allowable range (TH_Duty(n)), the variation in bleeding is small for the n-th color, and one of the n-th color minimum value Dt_pmin(n) and the n-th color maximum value Dt_pmax(n) is determined to be the ejection amount upper limit value (Dt_final(n)) for the n-th color. When the difference Dt_pdif(n) between the n-th color maximum value Dt_pmax(n) and the n-th color minimum value Dt_pmin(n) exceeds the n-th color allowable range (TH_Duty(n)), the variation in bleeding is large for the n-th color, and the ejection amount upper limit value (Dt_final(n)) for the n-th color is determined so as to be larger than the n-th color minimum value Dt_pmin(n) and also smaller than the n-th color maximum value Dt_pmax(n). Therefore, in the above aspect, it is possible to determine the ejection amount upper limit value for the n-th color that suppresses excessive deterioration of the coloration property and the excessive bleeding of the liquid, even if the variation in bleeding is large for the n-th color.

### Fourth Aspect

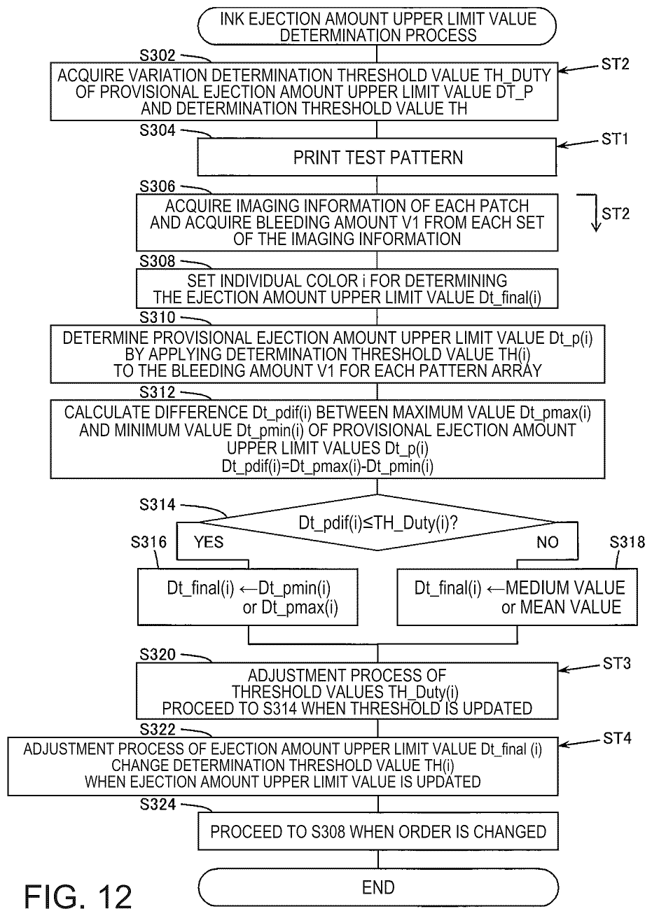

As illustrated in FIG. 3, the test pattern 500 may include an individual color test pattern 504 of an individual color, which is included in a plurality of colors in which the bleeding detection region (532) of the patch is an n-th color, where n is an integer that is 1 or more and also that is less than the number of types of the liquid (236). The provisional ejection amount upper limit value Dt_p may include the individual color provisional ejection amount upper limit value Dt_p(i) for the individual color test pattern 504. The allowable range (TH_Duty) may include an individual color allowable range (for example, a threshold TH_Duty(i)) for the individual color. As illustrated in FIG. 12, the upper limit value determination step ST2 may include the following steps.

(d1) a step (for example, steps S306 to S310) of, for each of the pattern arrays P0 in the individual color test pattern 504, determining the individual color provisional ejection amount upper limit value Dt_p(i) based on the reading results (322) of the plurality of patches 510 included in the pattern arrays P0. (d2) a step (for example, step S316) of determining one of the individual color minimum value Dt_pmin(i) and the individual color maximum value Dt_pmax(i) to be the upper limit value Dt_final (for example, Dt_final(i) for the individual color, when a difference Dt_pdif(i) between an individual color maximum value Dt_pmax(i), which is a maximum value of the plurality of individual color provisional ejection amount upper limit values Dt_p(i), and an individual color minimum value Dt_pmin(i), which is a minimum value of the plurality of individual color provisional ejection amount upper limit values Dt_p(i), is within the individual color allowable range (TH_Duty(i)). (d3) a step (for example, step S318) of determining the upper limit value (Dt_final(i)) for the individual color so as to be larger than the individual color minimum value Dt_pmin(i) and also smaller than the individual color maximum value Dt_pmax(i), when the difference Dt_pdif(i) between the individual color maximum value Dt_pmax(i) and the individual color minimum value Dt_pmin(i) exceeds the individual color allowable range (TH_Duty(i)). When the difference Dt_pdif(i) between the individual color maximum value Dt_pmax(i) and the individual color minimum value Dt_pmin(i) is within the individual color allowable range (TH_Duty(i)), the variation in bleeding for the individual color is small, and one of the individual color minimum value Dt_pmin(i) and the individual color maximum value Dt_pmax(i) is determined as the ejection amount upper limit value (Dt_final(i)) for the individual color. When the difference Dt_pdif(i) between the individual color maximum value Dt_pmax(i) and the individual color minimum value Dt_pmin(i) exceeds the individual color allowable range (TH_Duty(i)), the variation in bleeding is large for the individual color, and the ejection amount upper limit value (Dt_final(i)) for the individual color is determined so as to be larger than the individual color minimum value Dt_pmin(i) and also smaller than the individual color maximum value Dt_pmax(i). Therefore, according to the above-described aspect, it is possible to determine the individual color ejection amount upper limit value at which excessive deterioration of the coloration property and excessive bleeding of the liquid is suppressed, even if variation in bleeding is large for the individual color.

Here, “first”, “second”, and the like in the present application are terms for identifying components included in a plurality of components that have similarities, and do not mean the order. This comment also applies to the following aspects.

### Fifth Aspect

As illustrated in FIG. 8 and the like, the present ejection amount upper limit value determination method may further include the following steps.

(a3) an allowable range update reception step ST3 of receiving an operation of updating the allowable range (TH_Duty) and updating the allowable range (TH_Duty) in response to the operation.

In this case, the user can update the allowable range (TH_Duty) of the bleeding variation as desired. Therefore, in the above aspect, it is possible to determine the ejection amount upper limit value reflecting the preference of the user.

### Sixth Aspect

As illustrated in FIG. 8 and the like, in the upper limit value determination step ST2, the provisional ejection amount upper limit value Dt_p may be determined with respect to each of the pattern arrays P0 by acquiring a bleeding amount V1 representing the degree of spreading in the bleeding detection region (532), which is included in each of the patches 510, from the reading results (322) of the plurality of patches 510 included in each of the pattern arrays P0, and comparing a determination threshold value TH corresponding to the upper limit of the bleeding amount V1 and each of the bleeding amounts V1. The present ejection amount upper limit value determination method may further include the following steps.

(a4) a determination threshold value change reception step ST4 of receiving a change in the determination threshold value TH.

In this case, the user can change the extent to which the bleeding is allowed as desired. Therefore, in the above aspect, it is possible to determine the ejection amount upper limit value reflecting the preference of the user.

### Seventh Aspect

As illustrated in FIG. 8 and the like, in the upper limit value determination step ST2, when the difference Dt_pdif is within the allowable range (TH_Duty), the minimum value Dt_pmin may be determined as the upper limit value Dt_final. According to this aspect, the ejection amount upper limit value can be determined with priority given to bleeding suppression when the bleeding variation is small.

### Eighth Aspect

As illustrated in FIG. 1, a printing device 1 according to an aspect of the present technology includes a print head 230, a control section 110, and a reading section (for example, an imaging section 261). The print head 230 ejects a plurality of kinds of liquids (236) with different colors to the medium ME0. The control section 110 controls the formation on the medium ME0 of a test pattern 500 including a plurality of pattern arrays P0, which are pattern arrays P0 including a plurality of patches 510 having different per unit area ejection amounts with allowable liquid (236) bleeding with respect to the liquid (236) and which are pattern arrays P0 wherein each of the patches 510 includes a bleeding detection region (532) and a background region (531) having a color different from that of the bleeding detection region (532), acquires the reading results (322) of the plurality of patches 510 included in the plurality of pattern arrays P0, and determines the upper limit value Dt_final of the ejection amount based on the reading results (322) of the plurality of patches 510. The reading section (261) reads at least a part of the plurality of patches 510. The control section 110 performs the following processes.

A first process (for example, steps S106 to S110) of determining, for each of the pattern arrays P0, a provisional ejection amount upper limit value Dt_p, which is a provisional value of the upper limit value Dt_final, based on the reading results (322) of the plurality of patches 510 included in the pattern arrays P0.

(e2) a second process (for example, S116) of determining one of the minimum value Dt_pmin and the maximum value Dt_pmax to be the upper limit value Dt_final, when the difference Dt_pdif between the maximum value Dt_pmax of the plurality of provisional ejection amount upper limit values Dt_p obtained for the plurality of pattern arrays P0 and the minimum value Dt_pmin of the plurality of provisional ejection amount upper limit values Dt_p is within an allowable range (TH_Duty).

(e3) a third process (for example, S118) of determining the upper limit value Dt_final so as to be larger than the minimum value Dt_pmin and also smaller than the maximum value Dt_pmax, when the difference Dt_pdif exceeds the allowable range (TH_Duty). According to the above-described aspect, it is possible to provide a printing device capable of determining an ejection amount upper limit value at which excessive deterioration of the coloration property is suppressed or excessive bleeding of the liquid is suppressed, even if the variation in bleeding is large.

Here, the reading section includes an imaging section such as a camera, an image reading section such as a scanner, and the like.

The control section may perform processing corresponding to the above-described second to seventh aspects. Further, the present technology can be applied to a printing method including the above-mentioned ejection amount upper limit value determination method, a composite device including the above-mentioned printing device, an ejection amount upper limit value determination program for realizing the above-mentioned ejection amount upper limit value determination method in a computer, a print control program for realizing the above-mentioned printing method in a computer, a computer readable storage medium on which any of the above-mentioned programs is recorded, and the like. Any of the foregoing devices may be comprised of a plurality of distributed portions.

### (2) Specific Example of Configuration of Printing Device

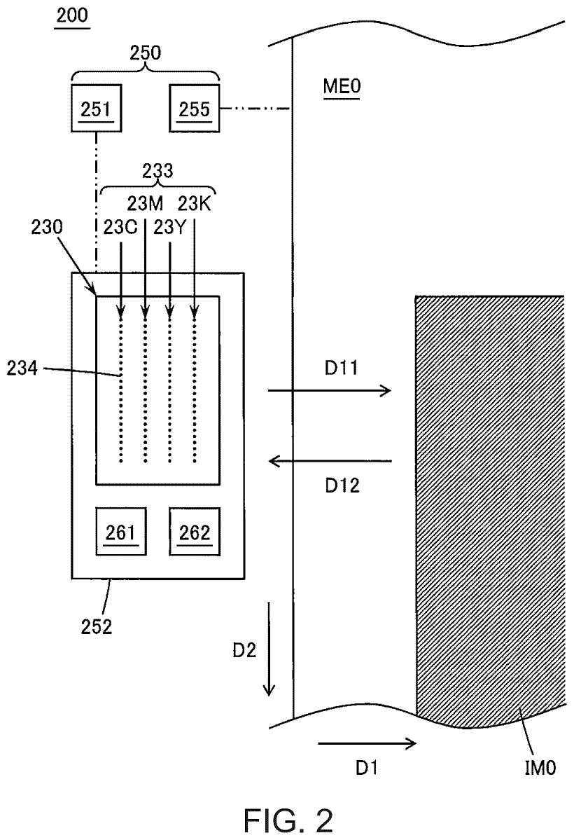

FIG. 1 schematically illustrates configuration of a printing device. FIG. 2 schematically illustrates operation of the printer. FIG. 3 schematically illustrates a test pattern on a medium.

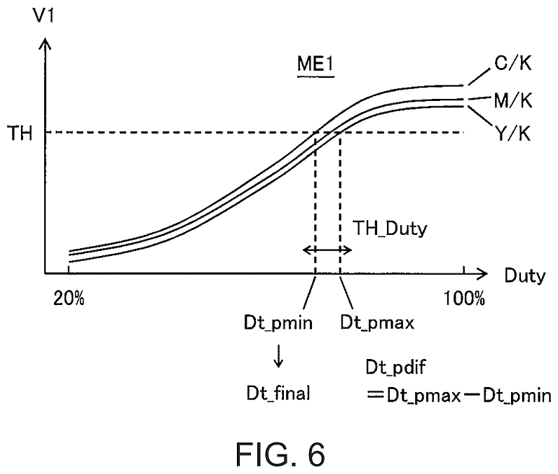

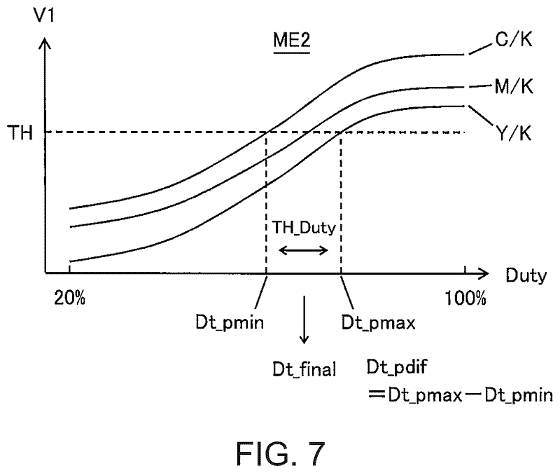

The printing device 1 shown in FIG. 1 is an apparatus in a broad sense including a host device 100 and a printer 200, and can be said to be a printing system. Of course, the printing device 1 may be a single printer 200. The host device 100 includes a central processing unit (CPU) 111, a read only memory (ROM) 112, a random access memory (RAM) 113, a storage device 114, an input device 115, a display device 116, a communication interface (I/F) 117, and the like. The above-mentioned elements (111 to 117) are electrically connected able to input and output information to and from each other. It should be noted that the ROM 112, the RAM 113, and the storage device 114 are memories, and at least the ROM 112 and the RAM 113 are semiconductor memories. The configuration of the printer 200 will be described later. The storage device 114 stores an operating system (OS) (not shown), a print control program PRO, test pattern data 321 used for printing a test pattern 500 shown in FIG. 3, a determination threshold value TH for a bleeding amounts V1 shown in FIGS. 6 and 7, and variation determination threshold values TH_Duty shown in FIGS. 6 and 7. Furthermore, the storage device 114 also stores imaging information 322 and the like generated by an imaging section 261 of the printer 200. The storage device 114 may be a nonvolatile semiconductor memory such as a flash memory, a magnetic storage device such as a hard disk, or the like. The input device 115 may be a pointing device, hard keys including a keyboard, a touch panel attached to the surface of a display panel, or the like. Based on display information, the display device 116 displays a screen corresponding to the display information. A liquid crystal display panel or the like can be used as the display device 116. The communication I/F 117 is connected to a communication I/F 220 of the printer 200, and inputs and outputs information such as print data to and from the printer 200. Communication by the communication I/Fs 117 and 220 may be wired, wireless, or network communication such as via LANs (Local Area Networks) and the Internet.

The print control program PRO causes the host device 100 to function as a test pattern formation process section 311, an upper limit value determination section 312, an allowable range update reception section 313, a determination threshold value change reception section 314, and the like. The test pattern formation process section 311 controls the formation of the test pattern 500 on the medium ME0. The upper limit value determination section 312 acquires the imaging information 322 of the plurality of patches 510 included in the test pattern 500, and determines the upper limit value Dt_final (see FIGS. 6 and 7) of the ink ejection amount Duty based on the imaging information 322. The allowable range update reception section 313 accepts an operation of updating the threshold value TH_Duty as the allowable range shown in FIGS. 6 and 7, and updates the threshold value TH_Duty in response to the operation. The determination threshold value change reception section 314 receives changes in the determination threshold value TH corresponding to the upper limit of the bleeding amount V1 shown in FIGS. 6 and 7. These elements (311 to 314) are discussed in more detail below. The print control program PRO causes the host device 100 to realize a test pattern formation process function FU1 corresponding to the test pattern formation process section 311, an upper limit value determination function FU2 corresponding to the upper limit value determination section 312, an allowable range update reception function FU3 corresponding to the allowable range update reception section 313, a determination threshold value change reception function FU4 corresponding to the determination threshold value change reception section 314, and the like. Note that the ejection amount upper limit value can be referred to as an ejection amount restriction value, and more specifically, as an ink Duty restriction value.

The CPU 111 of the host device 100 performs various processes by appropriately reading out information stored in the storage device 114 to the RAM 113, and executing the read out program. The CPU 111 executes the print control program PRO read out to the RAM 113 to perform processing corresponding to the functions (FU1 to FU4) described above. The CPU 111 for executing the print control program PRO is an example of a control section 110, and performs steps corresponding to the functions (FU1 to FU4) described above. A computer readable storage medium storing the print control program PRO is not limited to an internal storage device in the host device, and may be a storage medium to the outside of the host device. It should be noted that the host device 100 includes a computer such as a personal computer, a mobile phone such as a smartphone, a digital camera, a digital video camera, and the like. The host device 100 may have all the components (111 to 117) in one housing, or may be composed of a plurality of devices divided so as to be able to communicate with each other. The present technology can be implemented even when at least a part of the printer 200 is located in the host device 100. The printer 200 shown in FIGS. 1 and 2 is an ink jet printer that forms a printed image IMO corresponding to print data by ejecting C ink, M ink, Y ink, and K ink, as ink 236 containing a color material, from the print head 230 onto the medium ME0. Here, ink 236 is an example of a liquid, ink droplets 237 ejected from the print head 230 are an example of droplets, C means cyan, M means magenta, Y means yellow, and K means black. Therefore, the ink 236 shown in FIG. 1 is four different colored types. The printer 200 includes a controller 210, the above-described communication I/F 220, a print head 230, a drive section 250, an imaging section 261, a colorimetry section 262, and the like. The imaging section 261 is an example of a reading section that reads a plurality of patches 510 included in the test pattern 500 for detecting the bleeding amount V1 (see FIGS. 6 to 8) representing the degree of spread.

The controller 210 includes a CPU 211, which is a processor, a ROM 212, a RAM 213, a color conversion section, a halftone processing section, a drive signal transmission section, and the like, and controls operations of the communication I/F 220, the print head 230, the drive section 250, the imaging section 261, the colorimetry section 262, and the like. The controller 210 controls ejection of the ink droplets 237 by the print head 230 and scanning by the drive section 250 based on the print data acquired from the host device 100. For example, it is assumed that the communication I/F 220 receives print data including RGB data in which each pixel has an integer value equal to or greater than 2⁸ gradations of R, G, and B. Here, R means red, G means green, and B means blue. The color conversion section is capable of converting the RGB data for each pixel into ink amount data having an integer value equal to or greater than the 2⁸ gradations of C, M, Y, and K. The halftone processing section can generate dot data in which the number of gradations is reduced by performing halftone processing on the ink amount data. The controller 210 can be constituted by a System on a Chip (SoC) or the like.

The printer 200 shown in FIG. 2 is a serial printer that performs printing while moving the carriage 252 in both directions along a first direction D1. Of course, the printer 200 may be a line printer having no carriage. A print head 230, an imaging section 261, and a colorimetry section 262 are mounted on the carriage 252. The drive section 250 includes a carriage drive section 251 for moving the carriage 252 in a forward direction D11 and a return direction D12 under the control of the controller 210, and a feed section 255 for feeding the medium ME0 in a second direction D2 under the control of the controller 210. Here, the forward direction D11 and the return direction D12 are directions along the first direction D1, the return direction D12 is a direction opposite to the forward direction D11, and the second direction D2 is a direction orthogonal to the first direction D1.

The print head 230 is provided with a drive circuit, drive elements, and the like, and performs printing by ejecting ink droplets 237 onto the medium ME0 from a plurality of nozzles 234 included in a nozzle array 233. Here, nozzle means a small hole from which ink droplets are ejected, and nozzle array means an arrangement of a plurality of nozzles. As the drive elements, piezoelectric elements for applying pressure to ink in pressure chambers that communicate with the nozzles 234, drive elements for generating bubbles in the pressure chambers by heat and ejecting ink droplets 237 from the nozzles 234, or the like can be used. A drive signal transmission section included in the controller 210 generates a drive signal based on print data, for example, a drive signal according to dot data, and outputs the drive signal to a drive circuit of the print head 230. The drive signal corresponds to a voltage signal applied to the drive elements of the print head 230. For example, if the binary dot data based on the print data is “dot formation”, the drive signal transmission section outputs a drive signal for ejecting ink droplets for dot formation. When the dot data is four level data, the drive signal transmission section outputs a drive signal for ejecting ink droplets for large dots if the dot data is “large dot formation”, outputs a drive signal for ejecting ink droplets for medium dots if the dot data is “medium dot formation”, and outputs a drive signal for ejecting ink droplets for small dots if the dot data is “small dot formation”.

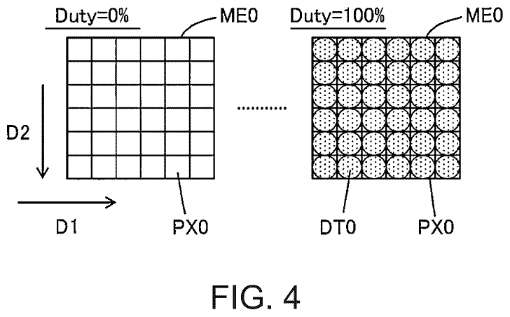

The print head 230 shown in FIG. 2 has a plurality of nozzle arrays 233 including a plurality of nozzles 234 arranged in the second direction D2 at intervals of a predetermined nozzle pitch, and is disposed on a surface of the carriage 252 facing the medium ME0. It should be noted that the arrangement direction of the plurality of nozzles 234 included in each nozzle array 233 may be shifted from the second direction D2 as long as it intersects with the first direction D1. The plurality of nozzle arrays 233 include a cyan nozzle array 23C for ejecting the C ink droplets 237, a magenta nozzle array 23M for ejecting the M ink droplets 237, a yellow nozzle array 23Y for ejecting the Y ink droplets 237, and a black nozzle array 23K for ejecting the K ink droplets 237. Each nozzle array 233 ejects ink droplets 237 toward the medium ME0. The plurality of nozzles 234 included in each nozzle array 233 may be arranged in one row, or may be arranged in a staggered manner, that is, in two rows. When the ink droplets 237 land on the medium ME0, dots DT0 (see FIG. 4) of the ink 236 are formed on the medium ME0. As a result, a printed object having the printed image IMO on the medium ME0 is obtained.

The medium ME0 includes, but is not limited to, paper, cloth, resin, metal, and the like. The shape of the medium ME0 may be a roll shape, a cut two dimensional shape, or a three dimensional shape.

The imaging section 261 includes an area sensor, images the individual patches 510 included in the test pattern 500 shown in FIG. 3, for example, patches 511 to 515, and outputs, as reading results, imaging information 322, which is an imaging result. It should be noted that the imaging section 261 may be provided with a line sensor instead of the area sensor. The imaging section 261 is disposed on a surface of the carriage 252 facing the medium ME0, and performs imaging when the carriage 252 moves in the first direction D1. The imaging section 261 shown in FIG. 2 is located at a position in the carriage 252 facing the second direction D2 from the print head 230. Thus, the imaging section 261 can pick up an image of patches formed during one main scanning, in a subsequent main scanning. The printer 200 transmits imaging information 322 generated by the imaging section 261 to the host device 100. The host device 100 may store the received imaging information 322 as is in the storage device 114, or may store updated imaging information 322, to which the additional information obtained from the received imaging information 322 was added, in the storage device 114.

The colorimetry section 262 can perform colorimetry on individual patches included in a colorimetry test pattern (not shown), and can output colorimetric information as a colorimetry result corresponding to the colors of the patches. The colorimetry result is different from the imaging result by the imaging section 261. The colorimetric information is, for example, color values representing lightness l * and chromaticity coordinates a * and b * of the International Commission on Illumination (CIE) l * a * b * color space. Of course, the colorimetric information may be color values in the CIE XYZ color space or the like.

As shown in FIG. 3, the test pattern 500 includes a plurality of pattern arrays P0, each including a plurality of patches 510 having different ejection amounts of ink 236. In the example shown in FIG. 3, the pattern arrays P0 are arranged in the first direction D1, and the plurality of patches 510, for example, patches 511 to 515, included in each pattern array P0 are arranged in the second direction D2. Of course, the arrangement direction of the pattern arrays and the arrangement direction of the patches in the pattern arrays are not limited to the example shown in FIG. 3 and, for example, the pattern arrays may be arranged in the second direction D2 and the patches in the pattern arrays may be arranged in the first direction D1.

The plurality of pattern arrays P0 include a plurality of pattern arrays P1 for detecting the bleeding amount V1 of primary colors, a plurality of pattern arrays P2 for detecting the bleeding amount V1 of secondary colors, and one or more pattern arrays P3 for detecting the bleeding amount V1 of tertiary colors. A primary color is a color expressed by only one type of ink, a secondary color is a color expressed by two types of ink having different colors, and a tertiary color is a color expressed by three types of ink having different colors. The pattern arrays P11 to P15 shown in FIG. 3 are examples of the pattern arrays P1 for primary colors. The pattern arrays P16 to P18 shown in FIG. 3 are examples of the pattern arrays P2 for secondary colors. The pattern array P19 shown in FIG. 3 is an example of a pattern array P3 for a tertiary color. Accordingly, the test pattern 500 includes a primary color test pattern 501 including a plurality of pattern arrays P1, a secondary color test pattern 502 including a plurality of pattern arrays P2, and a tertiary color test pattern 503 including one or more pattern arrays P3. n-th color test pattern 50n is a generic name for the primary color test pattern 501, the secondary color test pattern 502, and the tertiary color test pattern 503. It should be noted that there are four kinds of ink 236 in this specific example, and the order n is an integer of 1 or more and also less than 4.

FIG. 4 is a diagram for schematically explaining an example of the ink ejection amount (referred to as Duty). In the example shown in FIG. 4, 6×6=36 six pixels PX0 are shown as a predetermined number of pixels PX0 corresponding to a unit area. Of course, the predetermined number corresponding to the unit area is not limited to 36, and a larger area may be treated as the unit area. The left side of FIG. 4 shows an example in which ink droplets 237 are not ejected to the predetermined number of pixels PX0 corresponding to the unit area. The right side of FIG. 4 shows an example in which dots DT0 of ink of a primary color are formed in all the pixels PX0 corresponding to the unit area. A pixel PX0 is the smallest element of the image to which a color can be independently assigned.

The ink ejection amount means the total amount of ink ejected per unit area. In other words, the ink ejection amount Duty means a ratio (including a percentage) of the number of ink droplets 237 ejected to a predetermined number of pixels PX0 and, in the case where ink droplets 237 of different sizes are ejected to the pixel PX0, means the ratio when converted into the largest ink droplet. For example, when Nd number of ink droplets 237 are ejected to 100 pixels, the ink ejection amount Duty is Nd %. As shown on the left side of FIG. 4, Duty=0% when ink droplets 237 are not ejected to the predetermined number of pixels PX0 and, as shown on the right side of FIG. 4, Duty=100% when ink droplets 237 of a primary color are ejected to all the pixels PX0. It should be noted that when a mixed-color image of a secondary color or the like is formed, since a plurality of types of ink droplets 237 are ejected to one pixel PX0, Duty>100% may occur. For example, the ink ejection amount Duty of the secondary color becomes 200% at the maximum.

Here, “ink color saturation” and “ink bleeding” will be described.

“Ink color saturation” means a phenomenon in which the coloration with respect to the ink ejection amount hardly changes, in other words, a phenomenon in which the coloration hardly changes even if the ink ejection amount increases. “Coloration” means the density of a printed image, such as a patch, and is represented by the lightness l of the Lab color space subtracted from 100 (100−L), the chroma (a²+b²)^{1/2} obtained from chromaticity coordinates a and b, and the like. “Ink bleeding” means a phenomenon in which the ink ejected to a certain region of the medium ME0 is not absorbed by the medium ME0, and ink pools up in an edge portion of the region, thereby causing unevenness. With respect to the ink 236 ejected from the print head 230 to the medium ME0, the control section 110 of the present embodiment determines an upper limit value Dt_final of the per unit area ejection amount with allowable bleeding of the ink 236.

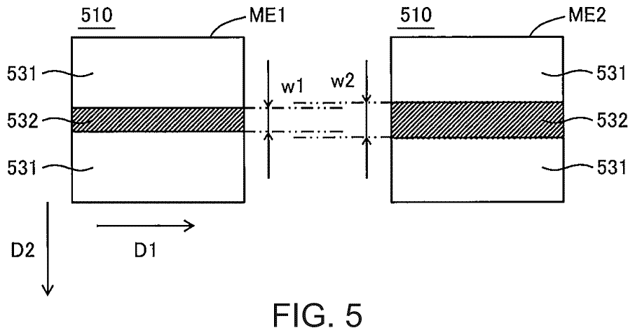

FIG. 5 schematically shows an example patch having a linear region for detecting the bleeding amount. The left side of FIG. 5 shows the patch 510 in which no ink bleeding occurs. The right side of FIG. 5 shows the patch 510 having ink bleeding.

The patch 510 includes two solid regions 531 and a linear region 532 between the solid regions 531. The linear region 532 is an example of a bleeding detection region of a target color for detecting the bleeding amount V1, and the solid region 531 is an example of a background region of a color different from the bleeding detection region. Each solid region 531 is a rectangular solid image having a color different from that of the linear region 532, and is in contact with the linear region 532. In the patch 510 shown in FIG. 5, the plurality of solid regions 531 are of the same color. Two solid regions 531 shown in FIG. 5 are divided into upper and lower regions, but may be divided into left and right regions, for example. The number of solid regions 531 included in each patch 510 may be three or more. The linear region 532 is a linear solid image having a color different from that of the solid regions 531, and is in contact with both of the solid regions 531. The linear region 532 is used to determine the presence or absence of ink bleeding.

Each pattern array P0 shown in FIG. 3 includes a plurality of patches 510, for example, rectangular patches 511 to 515, in which the ink ejection amount ejected to the solid regions 531 and the linear region 532 gradually varies. It should be noted that the pattern array P11 includes a plurality of patches in which the ejection amount of the K ink with respect to the solid regions 531 gradually decreases from 100% and also the ejection amount of the C ink with respect to the linear region 532 gradually decreases from 100%. The pattern array P12 includes a plurality of patches in which the ejection amount of the Y ink with respect to the solid regions 531 gradually decreases from 100% and also the ejection amount of the C ink with respect to the linear region 532 gradually decreases from 100%. The pattern array P13 includes a plurality of patches in which the ejection amount of the C ink with respect to the solid regions 531 gradually decreases from 100% and also the ejection amount of the M ink with respect to the linear region 532 gradually decreases from 100%. The pattern array P14 includes a plurality of patches in which the ejection amount of the M ink with respect to the solid regions 531 gradually decreases from 100% and also the ejection amount of the Y ink with respect to the linear region 532 gradually decreases from 100%. The pattern array P15 includes a plurality of patches in which the ejection amount of the Y ink with respect to the solid regions 531 gradually decreases from 100% and also the ejection amount of the K ink with respect to the linear region 532 gradually decreases from 100%. The pattern array P16 includes a plurality of patches in which the ejection amount of the K ink for the solid regions 531 gradually decreases from 100% and also the total ejection amount of the C ink and the M ink for the linear region 532 gradually decreases from 100%. The pattern array P17 includes a plurality of patches in which the ejection amount of the M ink for the solid regions 531 gradually decreases from 100% and also the total ejection amount of the C ink and the Y ink for the linear region 532 gradually decreases from 100%. The pattern array P18 includes a plurality of patches in which the ejection amount of the C ink with respect to the solid regions 531 gradually decreases from 100% and also the total ejection amount of the M ink and the Y ink with respect to the linear region 532 gradually decreases from 100%. The pattern array P19 includes a plurality of patches in which ink is not ejected to the solid regions 531 and also the total ejection amount of the C ink, the M ink, and the Y ink for the linear region 532 gradually decreases from 100%.

From the above, the pattern arrays P11 to P15 are the pattern array P1 of the primary color test pattern 502 in which the linear region 532 is a primary color, and the pattern arrays P16 to P18 are the pattern array P2 of the secondary color test pattern 501 in which the linear region 532 is a secondary color. The pattern array P19 is the pattern array P3 of the tertiary color test pattern 503 in which the linear region 532 is a tertiary color.

It should be noted that the patches 510 of the pattern arrays P11 and P12 share the feature of having a linear region 532 of C ink. Therefore, the pattern arrays P11 and P12 constitute an individual color test pattern 504, which is an individual color included in a plurality of colors of which the linear region 532 of the patch 510 is a primary color. In this specific example, the individual colors included in the plurality of primary colors are C, M, Y, and K. The individual colors included in the plurality of colors that are secondary colors include a combination of C and M, a combination of C and Y, and a combination of M and Y. The individual colors included in the plurality of colors that are the tertiary color include the combination of C, M, and Y.

When the solid region 531 and the linear region 532 are primary colors, the interval between the ink ejection amounts of the patches is not particularly limited, and may be an interval of 5%, an interval of 10%, or the like. When the linear region 532 is a secondary color, the interval of the ink ejection amounts of the patches is not particularly limited, and may be an interval of 10%, an interval of 20%, or the like.

Of course, the pattern array P0 is not limited to the example shown in FIG. 3. For example, the test pattern 500 may include a pattern array in which the linear region 532 is C and the solid region 531 is M, or may include a pattern array in which the solid region 531 is a secondary color. The solid region 531 may be a bleeding detection region instead of the linear region 532 and the linear region 532 may be a background region instead of the solid region 531.

FIG. 5 schematically illustrates bleeding occurring in the patch 510. The left side of FIG. 5 shows a patch 510 formed on a medium ME1 in which ink is unlikely to bleed. The right side of FIG. 5 shows a patch 510 formed on the medium ME2 in which ink is likely to bleed. For example, glossy paper is an example of the medium ME1 in which ink is unlikely to bleed, and plain paper and cloth are examples of a medium ME2 in which ink is more likely to bleed.

In the outline portion of the linear region 532 formed on the medium ME1 in which the ink is unlikely to bleed, there is no roughness due to bleeding. The outline portion of the linear region 532 formed on the medium ME2, in which the ink is likely to bleed, is found to be rough due to bleeding. In the medium ME2 in which the ink easily spreads, the ink of the linear region 532 spreads to the periphery, so that the width w2 of the linear region 532 formed in the medium ME2 becomes wider than the width w1 of the linear region 532 formed in the medium ME1 in which the ink is unlikely to spread. Therefore, the width of the linear region 532 indicates the bleeding amount V1 representing the degree of spreading, and it can be said that the degree of spreading increases as the width of the linear region 532 increases. Ink bleeding is more likely to occur as the ink ejection amount ejected increases.

When the imaging section 261 shown in FIG. 1 captures an image of the patch 510, then, based on the imaging information 322, the upper limit value determination section 312 can acquire the width of the linear region 532 as the bleeding amount V1. The upper limit value determination section 312 compares the bleeding amount V1 with a determination threshold value TH (see FIGS. 6 to 8), and determines that there is ink bleeding when V1>TH, and determines that there is no ink bleeding when V1≤TH. The upper limit value determination section 312 obtains the maximum ink ejection amount that becomes V1≤TH as a provisional ejection amount upper limit value Dt_p (see FIG. 8) for each pattern array P0.

The determination threshold value TH (TH>0) used for determining the presence or absence of ink bleeding can be determined in advance by a plurality of testers (persons performing sensory evaluation) performing sensory evaluation of a plurality of test patterns printed on the medium ME0. For example, a plurality of types of test patterns including the patch 510 as shown in FIG. 5 are prepared corresponding to the degree of the width of the linear region 532, and are printed on the medium ME0. The testers visually check the plurality of types of test patterns printed on the medium ME0, and perform a sensory evaluation such as selecting patches in which the occurrence of ink bleeding can be visually recognized. The determination threshold value TH is determined by statistically analyzing the results of the same sensory evaluation performed by a plurality of testers. Once the final determination threshold value TH is determined from the analysis result, a histogram may be created with the widths of the linear regions 532 as bins, and the width of the peak frequency may be used as the determination threshold value TH, or a weighted mean may be used as the determination threshold value TH. The determination threshold value TH may take the design specification of the printing device 1 into consideration. The presence or absence of ink bleeding is determined according to the determination threshold value TH obtained, thereby obtaining a result that conforms to human senses. The determined determination threshold value TH is stored in the storage device 114. The degree of bleeding occurring in each patch 510 may vary depending on the type of the print medium ME0. Generally, the variation in the bleeding amount V1 of patches 510 formed on the medium ME1 in which ink is unlikely to spread is relatively small, and the variation in the bleeding amount V1 of patches 510 formed on the medium ME2 in which ink is likely to spread is relatively large. In the case where the ejection amount restriction value is set separately for each color order, variations in the bleeding amount V1 between colors are likely to occur because, as shown in FIG. 2, the print head 230 has nozzles 234 of C, M, Y, and K at different positions. It is considered that this is because the landing state of the ink droplets 237 tends to vary between colors.

FIG. 6 schematically illustrates how the ejection amount upper limit value Dt_final is determined when the variation in the bleeding amount V1 is small, as in the case of patches 510 formed on a medium ME1 in which ink is unlikely to spread. FIG. 7 schematically illustrates how the ejection amount upper limit value Dt_final is determined when the variation of the bleeding amount V1 is large, as in the case of patches 510 formed on the medium ME2 in which ink is easily spread. In FIGS. 6 and 7, the horizontal axis represents the ink ejection amount Duty, and the vertical axis represents the bleeding amount V1. “C/K”, “M/K”, and “Y/K” indicate “the color of the linear region 532/the color of the solid region 531”. That is, “C/K” indicates the curve of the bleeding amount V1 obtained from the imaging result of the pattern array P1 for the primary color including a plurality of patches 510 having a linear region 532 of C and a solid region 531 of K, wherein the plurality of patches 510 have different ink ejection amounts Duty. “M/K” indicates the curve of the bleeding amount V1 obtained from the imaging result of the pattern array P1 for the primary color including a plurality of patches 510 having a linear region 532 of M and a solid regions 531 of K, wherein the plurality of patches 510 have different ink ejection amounts Duty. “Y/K” indicates a curve of the bleeding amount V1 obtained from the imaging result of the pattern array P1 for the primary color, which includes a plurality of patches 510 having a linear region 532 of Y and solid regions 531 of K, wherein the plurality of patches 510 have different ink ejection amounts Duty.

The upper limit value determination section 312 determines a provisional ejection amount upper limit value Dt_p (see FIG. 8), which is a provisional value of the ejection amount upper limit value Dt_final, for each pattern array P1 based on the imaging results of the plurality of patches 510 included in the pattern array P1. The provisional ejection amount upper limit value Dt_p means the maximum ink ejection amount Duty at which the bleeding amount V1 does not exceed the determination threshold value TH for each pattern array P1. FIGS. 6 and 7 show that the provisional ejection amount upper limit value Dt_p of “C/K” is the minimum value Dt_pmin, and the provisional ejection amount upper limit value Dt_p of “Y/K” is the maximum value Dt_pmax. When the variation of the provisional ejection amount upper limit value Dt_p is small as shown in FIG. 6, the upper limit value determination section 312 determines the minimum value Dt_pmin or the maximum value Dt_pmax as the ejection amount upper limit value Dt_final.

When the variation of the provisional ejection amount upper limit value Dt_p is large as shown in FIG. 7, then if the minimum value Dt_pmin is determined to be the ejection amount upper limit value Dt_final, the coloration property will deteriorate, and the color gamut that can be expressed by the printer 200 will narrow. It should be noted that the pattern array P1 for which the minimum value Dt_pmin is determined has a patch 510 in which the bleeding amount V1 of the linear region 532 is larger than those of the rest of the pattern array P1. When the color gamut of the printer 200 narrows, the coloration property of the printed image IMO is greatly reduced, and the image quality of the printed image IMO is reduced.

On the other hand, the pattern array P1 in which the maximum value Dt_pmax is determined has a patch 510 in which the bleeding amount V1 of the linear region 532 is smaller than those of the rest of the pattern array P1. Therefore, if the maximum value Dt_pmax is set to the ejection amount upper limit value Dt_final when variation of the provisional ejection amount upper limit value Dt_p is large, then the degree of bleeding of the ink 236 may become excessively large. When the degree of bleeding of the ink 236 becomes too large, the image quality of the printed image IMO deteriorates.

Therefore, when the variation of the provisional ejection amount upper limit value Dt_p is large, the upper limit value determination section 312 of this embodiment determines the ejection amount upper limit value Dt_final to be larger than the minimum value Dt_pmin and also smaller than the maximum value Dt_pmax.

Whether or not variation in the provisional ejection amount upper limit value Dt_p is large can be determined, for example, by whether or not the difference (Dt_pdif) between the maximum value Dt_pmax and the minimum value Dt_pmin exceeds the threshold value TH_Duty, which is the allowable range. When the difference Dt_pdif does not exceed the threshold value TH_Duty as shown in FIG. 6, the upper limit value determination section 312 determines the minimum value Dt_pmin or the maximum value Dt_pmax as the ejection amount upper limit value Dt_final. When the difference Dt_pdif exceeds the threshold value TH_Duty as shown in FIG. 7, the upper limit value determination section 312 determines the ejection amount upper limit value Dt_final to be larger than the minimum value Dt_pmin and also smaller than the maximum value Dt_pmax. Since the ejection amount upper limit value Dt_final is larger than the minimum value Dt_pmin, excessive deterioration of the coloration property of the printed image IMO is suppressed. Since the ejection amount upper limit value Dt_final is smaller than the maximum value Dt_pmax, excessive bleeding of the ink 236 is suppressed. Therefore, in this embodiment, it is possible to determine the ejection amount upper limit value Dt_final that suppresses excessive deterioration of the coloration property or excessive bleeding of the ink 236, even if variation in bleeding is large.

### (3) Specific Example of Ink Ejection Amount Upper Limit Value Determination Process

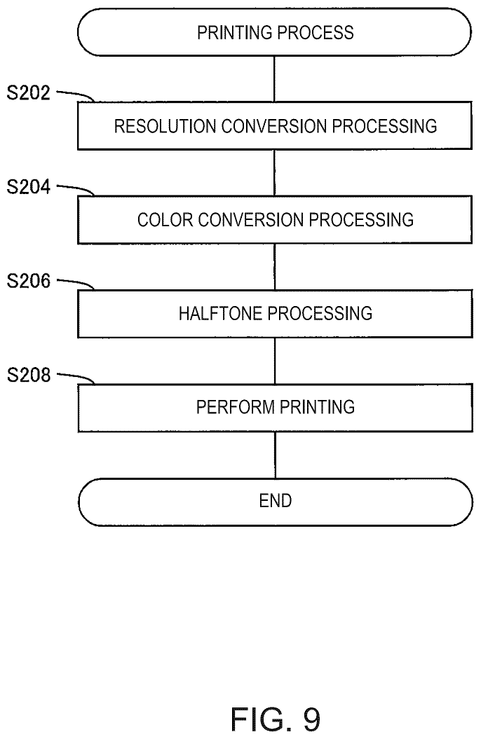

FIG. 8 schematically illustrates an ink ejection amount upper limit value determination process for determining the ink ejection amount upper limit value Dt_final. FIG. 9 schematically illustrates a printing process performed by the printer 200 in step S104 of the ink ejection amount upper limit value determination process. Below, the ink ejection amount upper limit value determination process will be described with reference to FIGS. 1 to 7.

The ink ejection amount upper limit value determination process in this embodiment is performed by the host device 100 including the control section 110 as shown in FIG. 1. The ink ejection amount upper limit value determination process starts when the host device 100 receives an operation at the input device 115 for determining the ejection amount upper limit value Dt_final. Here, step S104 corresponds to the test pattern formation step ST1, the test pattern formation process section 311, and the test pattern formation process function FU1. Steps S102 and S106 to S118 correspond to the upper limit value determination step ST2, the upper limit value determination section 312, and the upper limit value determination function FU2. Step S120 corresponds to the allowable range update reception step ST3, the allowable range update reception section 313, and the allowable range update reception function FU3. Step S122 corresponds to the determination threshold value change reception step ST4, the determination threshold value change reception section 314, and the determination threshold value change reception function FU4. Hereinafter, the word “step” may be omitted, and reference numerals of steps may be indicated in parentheses.

When the ink ejection amount upper limit value determination process is started, the host device 100 acquires the variation determination threshold value TH_Duty of the provisional ejection amount upper limit value Dt_p and the determination threshold value TH corresponding to the upper limit of the bleeding amount V1 (S102). The threshold value TH_Duty and the determination threshold value TH are stored in the storage device 114 for each type of medium ME0. Therefore, the host device 100 should acquire, from the storage device 114, the threshold value TH_Duty and the determination threshold value TH corresponding to the type of the medium ME0 to be subjected to the test pattern printing from a list of threshold values TH_Duty and determination threshold values TH. Here, the threshold values TH_Duty include threshold values TH_Duty(n) for each color order n, for example, threshold values TH_Duty(1) for primary colors, threshold values TH_Duty(2) for secondary colors, and threshold values TH_Duty(3) for tertiary colors. The threshold value TH_Duty(n) is an example of an n-th color allowable range, which is an allowable range for an n-th color. The determination threshold values TH include determination threshold values TH(n) for each color order n, for example, determination threshold values TH (1) for primary colors, determination threshold values TH (2) for secondary colors, and determination threshold values TH (3) for tertiary colors. The provisional ejection amount upper limit value Dt_p includes and n-th color provisional ejection amount upper limit value Dt_p(n) for an n-th color test pattern 50n, for example, a primary color provisional ejection amount upper limit value Dt_p (1), a secondary color provisional ejection amount upper limit value Dt_p (2), and a tertiary color provisional ejection amount upper limit value Dt_p (3). The maximum value Dt_pmax of the provisional ejection amount upper limit value Dt_p includes an n-th color maximum value Dt_pmax(n), which is a maximum value of the n-th color provisional ejection amount upper limit value Dt_p(n). The minimum value Dt_pmin of the provisional ejection amount upper limit value Dt_p includes an n-th color minimum value Dt_pmin(n), which is the minimum value of the n-th color provisional ejection amount upper limit value Dt_p(n).

After S102, the host device 100 performs a process of causing the printer 200 to print the test pattern 500 including a plurality of pattern arrays P0, each containing a plurality of patches 510, each with a different ink ejection amount Duty (S104). The test pattern 500 includes an n-th color test pattern 50n. The host device 100 transmits the test pattern data 321 shown in FIG. 1 to the printer 200. Here, it is assumed that the test pattern data 321 is RGB data. As shown in FIG. 9, the printer 200 first performs resolution conversion processing for converting the test pattern data 321 into print resolution (S202). When the test pattern data 321 is at the printing resolution, the resolution conversion processing. Next, the printer 200 performs color conversion processing for converting the test pattern data 321 into ink amount data (S204). It should be noted that when the color test pattern data 321 is ink amount data, the color conversion process is unnecessary. Next, the printer 200 performs halftone processing for converting the ink amount data into binary or four valued dot data (S206). It should be noted that when the test pattern data 321 is dot data, the halftone processing is unnecessary. If necessary, the printer 200 performs rasterization processing for rearranging the dot data into the printing order. Finally, the printer 200 generates a drive signal in accordance with the dot data, and forms a test pattern 500 including a plurality of pattern arrays P0 corresponding to the test pattern data 321 on the medium ME0 (S208).

It should be noted that the processes of S202 to S206 may be performed by the host device 100, the processes of S202 to S204 may be performed by the host device 100, and the process of S202 may be performed by the host device 100.

After printing the test pattern 500, the host device 100 causes the printer 200 to execute imaging, acquires the imaging information 322 of the plurality of patches 510 included in the test pattern 500 from the printer 200, and acquires the bleeding amount V1 from each set of the imaging information 322 (S106). The printer 200 having received the imaging instruction backfeeds the medium ME0, and the imaging section 261 images each patch 510 included in the test pattern 500. When the printer 200 transmits the imaging information 322 from the imaging section 261 to the host device 100, the host device 100 acquires the imaging information 322 and stores it in the storage device 114. The host device 100 calculates the bleeding amount V1 for each patch 510 based on the imaging information 322 and stores them in the storage device 114.

After S106, the host device 100 sets the order n for determining the ejection amount upper limit value Dt_final (S108). Next, the host device 100 determines the n-th color provisional ejection amount upper limit value Dt_p(n) by applying the determination threshold value TH(n) to the bleeding amount V1 for each pattern array P0 in the n-th color test pattern 50n (S110). The host device 100 can determine the maximum ink ejection amount Duty at which the bleeding amount V1 does not exceed the determination threshold value TH(n) for each pattern array P0 of the n-th color to be the provisional ejection amount upper limit value Dt_p(n) of the n-th color. Therefore, it can be said that the process of S110 is a process for determining the n-th color provisional ejection amount upper limit value Dt_p(n) by comparing the determination threshold value TH(n) with each of the bleeding amounts V1 for each pattern array P0 of the n-th color.

As described above, the upper limit value determination section 312 determines the n-th color provisional ejection amount upper limit value Dt_p(n) for each pattern array P0 in the n-th color test pattern 50n based on the reading results of the plurality of patches 510 included in the pattern array P0.

After S110, the host device 100 calculates the difference Dt_pdif(n) between the n-th color maximum value Dt_pmax(n) and the n-th color minimum value Dt_pmin(n) in the plurality of n-th color provisional ejection amount upper limit values Dt_p(n) (S112). Next, the host device 100 determines whether or not the difference Dt_pdif(n) is equal to or less than the variation determination threshold value TH_Duty(n) (S114).

When the difference Dt_pdif(n) is equal to or smaller than the threshold value TH_Duty(n), the difference Dt_pdif(n) is within the n-th color allowable range. In this case, the host device 100 determines the n-th color minimum value Dt_pmin(n) to be the ejection amount upper limit value Dt_final(n) for the n-th color (S116). Instead of the n-th color minimum value Dt_pmin(n), the host device 100 may determine the n-th color maximum value Dt_pmax(n) to be the ejection amount upper limit value Dt_final(n) for the n-th color. The host device 100 may display the determined ejection amount upper limit value Dt_final(n) on the display device 116. Since all the host device 100 has to do is set the n-th color minimum value Dt_pmin(n) or the n-th color maximum value Dt_pmax(n) to be the ejection amount upper limit value Dt_final(n) without changing them, the memory size required for the process of S116 may be small, and the time required for the process of S116 may be short.

When the difference Dt_pdif(n) is larger than the threshold value TH_Duty(n), then the difference Dt_pdif(n) exceeds the n-th color allowable range. In this case, the host device 100 determines the median value of the plurality of n-th color provisional ejection amount upper limit values Dt_p(n) to be the ejection amount upper limit value Dt_final(n) for the n-th color (S118). “Median value” means the n-th color provisional ejection amount upper limit value Dt_p(n) that is closest to the center when a plurality of the n-th color provisional ejection amount upper limit values Dt_p(n) are arranged in order of magnitude. When the number of n-th color provisional ejection amount upper limit values Dt_p(n) is an even number, the host device 100 may determine either of the two n-th color provisional ejection amount upper limit values Dt_p(n) that are closest to the middle as the ejection amount upper limit value Dt_final(n). It should be noted that the process of S118 requires a larger memory space than the process of S116 because memory space is required for storing the plurality of n-th color provisional ejection amount upper limit values Dt_p(n) in order to search for the median value from the plurality of n-th color provisional ejection amount upper limit values Dt_p(n). Instead of the median value, the host device 100 may determine the mean value of the plurality of n-th color provisional ejection amount upper limit values Dt_p(n) to be the ejection amount upper limit value Dt_final(n) for the n-th color. “Mean value” refers to a value obtained by calculating the mean using the plurality of n-th color provisional ejection amount upper limit values Dt_p(n) and the number of orders n, such as an arithmetic mean value obtained by dividing the sum of the plurality of n-th color provisional ejection amount upper limit values Dt_p(n) by the number of orders n. The process of S118 for determining the mean value to the ejection amount upper limit value Dt_final(n) requires a larger memory size and takes a longer time than the process of S116. On the other hand, since the ejection amount upper value the limit Dt_final(n) is aforementioned median value or mean value, it is larger than the n-th color minimum value Dt_pmin(n) and also smaller than the n-th color maximum value Dt_pmax(n). The host device 100 may display the determined ejection amount upper limit value Dt_final(n) on the display device 116.

After S116 or S118, the host device 100 may adjust the variation determination threshold values TH_Duty(n) as necessary (S120). In S120, the host device 100 can receive an operation at the input device 115 of FIG. 1 of updating the threshold value TH_Duty(n), and can update the threshold value TH_Duty(n) in response to the operation.

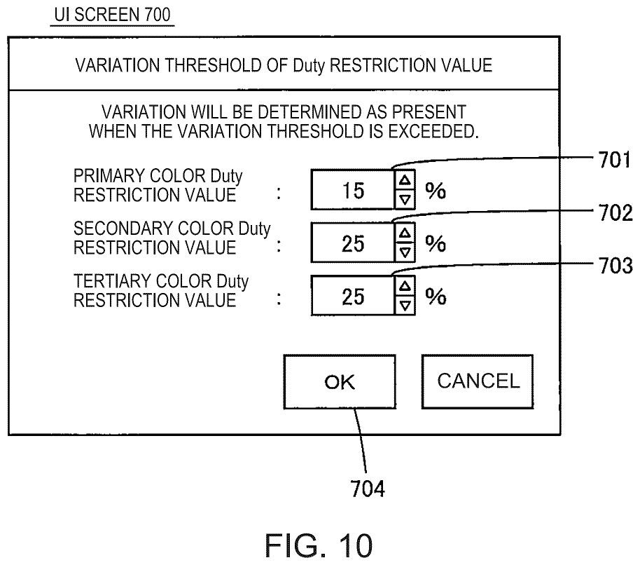

FIG. 10 schematically illustrates a user interface (UI) screen displayed in S120. The UI screen 700 shown in FIG. 10 has a primary color threshold value input field 701, a secondary color threshold value input field 702, a tertiary color threshold value input field 703, an OK button 704, and the like. The host device 100 stores in the storage device 114 the variation determination threshold value TH_Duty(n) for the n-th color. The initial threshold value TH_Duty(n) is a default value.

In the primary color threshold value input field 701, the host device 100 displays the primary color threshold value TH_Duty(1) stored in the storage device 114, and receives input of the threshold value TH_Duty(1). In the secondary color threshold value input field 702, the host device 100 displays the secondary color threshold value TH_Duty(2) stored in the storage device 114, and receives input of the threshold value TH_Duty(2). In the tertiary color threshold value input field 703, the host device 100 displays the tertiary color threshold value TH_Duty(3) stored in the storage device 114, and receives input of the threshold value TH_Duty(3). When the host device 100 receives the operation of the OK button 704 through the input device 115, the host device 100 stores the content of the operation on the UI screen 700 in the storage device 114. When at least one of the threshold values TH_Duty(n) is changed, the host device 100 returns the process to S114. By this, in S114, the host device 100 determines whether or not the difference Dt_pdif(n) is equal to or smaller than the updated threshold value TH_Duty(n).

For example, assuming that the primary color threshold value TH_Duty(1) is 15% and the difference Dt_pdif (1) is 12%, then because the result in S114 is Dt_pdif (1)≤TH_Duty (1), the primary color minimum value Dt_pmin (1) is determined in S116 to be the upper limit value Dt_final (1) and displayed. Here, it is assumed that the user who has grasped the determined upper limit value Dt_final (1), desires to improve the coloration property of the printed image IMO by allowing slightly more bleeding. In order to realize this desire, the effect can be obtained by decreasing TH_Duty and arbitrarily narrowing the selection width of the ink ejection amount Duty. In this example, when the user updates the primary color threshold value TH_Duty(1) to 10%, the result becomes Dt_pdif (1)>TH_Duty (1) in S114, and the above-mentioned median value or mean value is determined in S118 to be the upper limit value Dt_final (1). By this, the upper limit value Dt_final (1) after the update becomes larger than the preupdate upper limit value Dt_final (1)=Dt_pmin (1), and the coloration property of the printed image IMO is improved.

As described above, the user can update the allowable range of the bleeding variation according to his or her preference. The host device 100 performing the process of S120 can determine the ejection amount upper limit value Dt_final reflecting the preference of the user.

The host device 100 may adjust the ejection amount upper limit value Dt_final(n) as necessary (S122). In S122, the host device 100 can accept an operation at the input device 115 of FIG. 1 of changing the ejection amount upper limit value Dt_final(n), and can change the ejection amount upper limit value Dt_final(n) in response to the operation. In addition, the host device 100 can change the determination threshold value TH(n) of the bleeding amount V1 to a determination threshold value corresponding to the changed ejection amount upper limit value Dt_final(n).

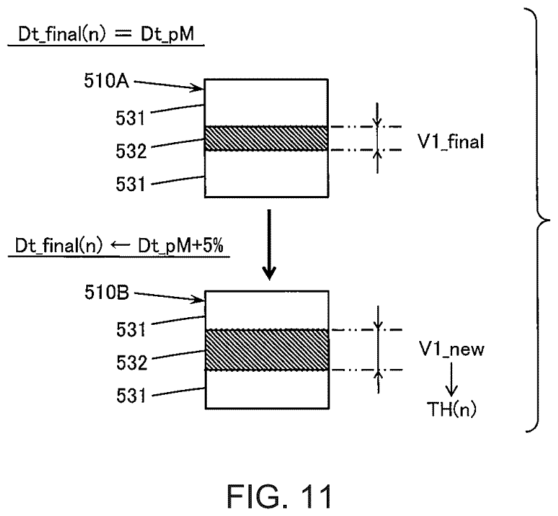

FIG. 11 schematically shows an example of receiving a change of the determination threshold value TH(n) in accordance with the ejection amount upper limit value Dt_final(n). In FIG. 11, the order n is 1, and each patch 510A and 510B has a linear region 532 between the solid regions 531.

The upper portion of FIG. 11 shows a state in which the ink ejection amount upper limit value Dt_final(n) is determined in S118 to be the provisional ejection amount upper limit value Dt_pM of the patch 510A of “M/K” when the difference Dt_pdif(n) between the n-th color maximum value Dt_pmax(n) and the n-th color minimum value Dt_pmin(n) is larger than the threshold value TH_Duty(n). The bleeding amount V1 of the patch 510A shown in the upper part of FIG. 11 is V1 final.

In S122, the host device 100 can accept the operation at the input device 115 of specifying the patch 510B corresponding to the new ejection amount upper limit value Dt_final(n). The host device 100 can acquire the changed ejection amount upper limit value Dt_final(n) corresponding to the specified patch 510B. The lower part of FIG. 11 shows a state in which the patch 510B, which has the ink ejection amount Duty of “M/K” that is 5% larger than the provisional ejection amount upper limit value Dt_pM, was specified. Since the patch 510B has a larger ink ejection amount Duty than that of the patch 510A, the bleeding amount V1_new of the patch 510B is larger than the bleeding amount V1 final of the patch 510A and is larger than the present determination threshold value TH(n).

In the above case, the host device 100 changes the ejection amount upper limit value Dt_final(n) from the provisional ejection amount upper limit value Dt_pM to Dt_pM+5%, and stores the changed ejection amount upper limit value Dt_final(n) in the storage device 114. In addition, the host device 100 updates the determination threshold value TH(n) to the bleeding amount V1_new of the patch 510B, and stores the changed determination threshold value TH(n) in the storage device 114. Therefore, the next time that the ink ejection amount upper limit value determination process is performed, in S110 the changed determination threshold value TH(n) is applied to the bleeding amount V1.

As described above, the host device 100 accepts the change of the determination threshold value TH. The user can change the extent to which bleeding is allowed according to his or her preference. The host device 100 performing the process of S122 can determine the ejection amount upper limit value Dt_final reflecting the preference of the user.

The host device 100 performs the processes from S108 to S122 for each order n. Therefore, when there remains an order n for which the processes of S108 to S122 have not been performed, the host device 100 returns the process to S108 (S124). When the processes of S108 to S122 have been performed for all the orders n, the host device 100 terminates the ink ejection amount upper limit value determination process.

As described above, when the difference Dt_pdif(n) between the maximum value Dt_pmax(n) and the minimum value Dt_pmin(n) in the n-th color provisional ejection amount upper limit values Dt_p(n) is within the n-th color allowable range (TH_Duty(n)), then one of the minimum value Dt_pmin(n) and the maximum value Dt_pmax(n) is determined as the ejection amount upper limit value Dt_final(n). When the difference Dt_pdif(n) between the maximum value Dt_pmax(n) and the minimum value Dt_pmin(n) exceeds the n-th color allowable range (TH_Duty(n)), then the ejection amount upper limit value Dt_final(n) is determined so as to be larger than the minimum value Dt_pmin(n) and also smaller than the maximum value Dt_pmax(n). Since the ejection amount upper limit value for the n-th color is larger than the minimum value Dt_pmin(n) of the n-th color provisional ejection amount upper limit values Dt_p(n), excessive deterioration of the coloration property of the printed image IMO is suppressed. Since the ejection amount upper limit value for the n-th color is smaller than the maximum value Dt_pmax(n) of the n-th color provisional ejection amount upper limit values Dt_p(n), excessive bleeding of the ink 236 is suppressed. Therefore, in the present embodiment, it is possible to determine the ejection amount upper limit value Dt_final at which excessive deterioration of the coloration property is suppressed or excessive bleeding of the ink 236 is suppressed, even if the variation in bleeding is large.

### (4) Application Examples

The ejection amount upper limit value Dt_final is not limited to being determined in units of the n-th color, but may be determined in units of an individual color included in a plurality of colors in which the linear region 532 of the patch 510 is an n-th color. For example, FIG. 3 shows an individual color test pattern 504 in which the linear region 532 of the patch 510 is the primary color C. Therefore, the host device 100 may determine the ejection amount upper limit value Dt_final in units of C in which the linear region 532 of the patch 510 is included in the primary color.

As another example, the individual color test pattern 504 for C may include a “C/M” pattern array P1, a “C/Y” pattern array P1, or a “C/K” pattern array P1. The individual color test pattern 504 for M may include a pattern array P1 of “M/C”, a pattern array P1 of “M/Y”, or a pattern array P1 of “M/K”. The individual color test pattern 504 for Y may include a pattern array P1 of “Y/C”, a pattern array P1 of “Y/M”, or a pattern array P1 of “Y/K”. The individual color test pattern 504 for K may include a pattern array P1 of “K/C”, a pattern array P1 of “K/M”, or a pattern array P1 of “K/Y”. Here, “color/color” such as “C/K” indicates “color of the linear region 532/color of the solid region 531”.

FIG. 12 schematically illustrates an ink ejection amount upper limit value determination process for determining the ink ejection amount upper limit value Dt_final(i) in units of an individual color i. Here, S304 corresponds to the test pattern formation step ST1, the test pattern formation process section 311, and the test pattern formation process function FU1. S302 and S306 to S318 correspond to the upper limit value determination step ST2, the upper limit value determination section 312, and the upper limit value determination section function FU2. S320 corresponds to the allowable range update reception step ST3, the allowable range update reception section 313, and the allowable range update reception function FU3. S322 corresponds to the determination threshold value change reception step ST4, the determination threshold value change reception section 314, and the determination threshold value change reception function FU4.

When the ink ejection amount upper limit value determination process starts, the host device 100 acquires the determination threshold value TH corresponding to the upper limit of the bleeding amount V1 and the variation determination threshold value TH_Duty for the provisional ejection amount upper limit value Dt_p (S302). Here, the threshold values TH_Duty include threshold values TH_Duty(i) for each individual color i, for example, threshold values TH_Duty (1) for the primary color C, threshold values TH_Duty (2) for the primary color M, threshold values TH_Duty (3) for the primary color Y, and threshold values TH_Duty (4) for the primary color K. Of course, an individual color is also included in secondary or greater colors. The threshold value TH_Duty(i) is an example of an individual color allowable range that is an allowable range for an individual color. The determination threshold values T include determination threshold values TH(i) for each individual color i, for example, determination threshold values TH (1) for the primary color C, determination threshold values TH (2) for the primary color M, determination threshold values TH (3) for the primary color Y, and determination threshold values TH (4) for the primary color K. The provisional ejection amount upper limit value Dt_p includes individual color provisional ejection amount upper limit values Dt_p(i) for the individual color test patterns 504, for example, a C provisional ejection amount upper limit value Dt_p (1), a M provisional ejection amount upper limit value Dt_p (2), a Y provisional ejection amount upper limit value Dt_p (3), a K provisional ejection amount upper limit value Dt_p (4), and the like. The maximum value Dt_pmax of the provisional ejection amount upper limit value Dt_p includes an individual color maximum value Dt_pmax(i), which is the maximum value of the individual color provisional ejection amount upper limit value Dt_p(i). The minimum value Dt_pmin of the provisional ejection amount upper limit value Dt_p includes an individual color minimum value Dt_pmin(i), which is the minimum value of the individual color provisional ejection amount upper limit value Dt_p(i).

After S302, the host device 100 performs processes for causing the printer 200 to print the individual color test patterns 504 included in the pattern arrays P0, each of which includes a plurality of patches 510, each having a different ink ejection amount Duty (S304). Next, the host device 100 causes the printer 200 to execute imaging, acquires from the printer 200 the imaging information 322 of the plurality of patches 510 included in the test pattern 500, and acquires the bleeding amount V1 from each set of the imaging information 322 (S306).

After S306, the host device 100 sets the individual color i for determining the ejection amount upper limit value Dt_final (S308). Next, the host device 100 determines the individual color provisional ejection amount upper limit value Dt_p(i) by applying the determination threshold value TH(i) to the bleeding amount V1 in the individual color test patterns 504 for each pattern array P0 (S310). The host device 100 can determine, for each pattern array P0 of the individual colors, the maximum ink ejection amount Duty at which the bleeding amount V1 does not exceed the determination threshold value TH(i) to be the individual color provisional ejection amount upper limit value Dt_p(i). Therefore, it can be said that the process of S310 is processing for determining the individual color provisional ejection amount upper limit value Dt_p(i) by comparing the determination threshold value TH(i) with each of the bleeding amounts V1 for each pattern array P0 of an individual color.

As described above, the upper limit value determination section 312 determines the individual color provisional ejection amount upper limit value Dt_p(i) for the individual color test patterns 504 in each pattern array P0, based on the reading results of the plurality of patches 510 included in the pattern arrays P0.

After S310, the host device 100 calculates the difference Dt_pdif(i) between the individual color maximum value Dt_pmax(i) and the individual color minimum value Dt_pmin(i) in the plurality of individual color provisional ejection amount upper limit values Dt_p(i) (S312). Next, the host device 100 determines whether or not the difference Dt_pdif(i) is equal to or less than the variation determination threshold value TH_Duty(i) (S314).

If the difference Dt_pdif(i) is less than or equal to the threshold value TH_Duty(i), then the difference Dt_pdif(i) is within the individual color allowable range. In this case, the host device 100 determines the individual color minimum value Dt_pmin(i) to be the ejection amount upper limit value Dt_final(i) for the individual color (S316). Instead of the individual color minimum value Dt_pmin(i), the host device 100 may determine the individual color maximum value Dt_pmax(i) to be the ejection amount upper limit value Dt_final(i) for the individual color. The host device 100 may display the determined ejection amount upper limit value Dt_final(i) on the display device 116. Since all the host device 100 has to do is set the individual color minimum value Dt_pmin(i) or the individual color maximum value Dt_pmax(i) to the ejection amount upper limit value Dt_final(i) without changing it, the memory capacity required for the process of S316 may be reduced, and the time required for the process of S316 may be shortened.

When the difference Dt_pdif(i) is larger than the threshold value TH_Duty(i), the difference Dt_pdif(i) exceeds the individual color allowable range. In this case, the host device 100 determines the median value of the plurality of individual color provisional ejection amount upper limit values Dt_p(i) to be the ejection amount upper limit value Dt_final(i) for the individual color (S318). It should be noted that the process of S318 requires a larger memory capacity than the process of S316 because memory capacity for storing the plurality of individual color provisional ejection amount upper limit values Dt_p(i) is required in order to search for the median value from the plurality of individual color provisional ejection amount upper limit values Dt_p(i). Instead of the median value, the host device 100 may determine the mean value of the plurality of individual color provisional ejection amount upper limit values Dt_p(i) to be the ejection amount upper limit value Dt_final(i) for the individual color. The process of S318 for determining the mean value to the ejection amount upper limit value Dt_final(i) requires a larger memory size than the process of S316 and takes a longer time. On the other hand, since the ejection amount upper limit value Dt_final(i) is the above-described median value or mean, it is larger than the individual color minimum value Dt_pmin(i) and also smaller than the individual color maximum value Dt_pmax(i). The host device 100 may display the determined ejection amount upper limit value Dt_final(i) on the display device 116.

After S316 or S318, the host device 100 may adjust the variation determination threshold values TH_Duty(i) as necessary (S320). In S320, the host device 100 can accept an operation at the input device 115 of FIG. 1 of updating the threshold value TH_Duty(i), and can update the threshold value TH_Duty(i) in response to the operation.

The host device 100 may adjust the ejection amount upper limit value Dt_final(i) as necessary (S322). In S322, the host device 100 can receive an operation at the input device 115 of FIG. 1 of changing the ejection amount upper limit value Dt_final(i), and can change the ejection amount upper limit value Dt_final(i) in response to the operation. In addition, the host device 100 can change the determination threshold value TH(i) of the bleeding amount V1 to a determination threshold value corresponding to the changed ejection amount upper limit value Dt_final(i).

If there remains an individual color i for which the processes from S308 to S322 have not been performed, the host device 100 returns the process to S308 (S324). When the processes from S308 to S322 have been performed for all the individual colors i, the host device 100 terminates the ink ejection amount upper limit value determination process.

As described above, when the difference Dt_pdif(i) between the maximum value Dt_pmax(i) and the minimum value Dt_pmin(i) in the individual color provisional ejection amount upper limit value Dt_p(i) is within the individual color allowable range (TH_Duty(i)), one of the minimum value Dt_pmin(i) and the maximum value Dt_pmax(i) is determined to be the ejection amount upper limit value Dt_final(i). When the difference Dt_pdif(i) between the maximum value Dt_pmax(i) and the minimum value Dt_pmin(i) exceeds the individual color allowable range (TH_Duty(i)), the ejection amount upper limit value Dt_final(i) is determined so as to be larger than the minimum value Dt_pmin(i) and also smaller than the maximum value Dt_pmax(i). Since the ejection amount upper limit value for the individual color is larger than the minimum value Dt_pmin(i) of the individual color provisional ejection amount upper limit value Dt_p(i), excessive deterioration of the coloration property of the printed image IMO is suppressed. Since the ejection amount upper limit value for the individual color is smaller than the maximum value Dt_pmax(i) of the individual color provisional ejection amount upper limit value Dt_p(i), excessive bleeding of the ink 236 is suppressed. Therefore, also in the present application example, it is possible to determine the ejection amount upper limit value Dt_final at which excessive deterioration of the coloration property is suppressed or excessive bleeding of the ink 236 is suppressed, even if the variation in bleeding is large.

### (5) Modifications

Various modifications of the present disclosure are conceivable.

For example, the combination of ink colors is not limited to C, M, Y, and K and, in addition to C, M, Y, and K, may include one or more colors selected from light cyan (Lc) having a density lower than C, light magenta (Lm) having a density lower than M, dark yellow (Dy) having a density higher than Y, light black (Lk) having a density lower than K, orange (Or), green (Gr), a transparent color, and the like. The present technology can also be applied to a case where a part of C, M, Y, and K is not included in the color combination of inks.

That which performs the ink ejection amount upper limit value determination process is not limited to a CPU, and may be an electronic component other than a CPU, such as an Application Specific Integrated Circuit (ASIC). Of course, the ink ejection amount upper limit value determination process may be performed by cooperation of a plurality of CPUs, or the ink ejection amount upper limit value determination process may be performed in cooperation with a CPU and another electronic component (for example, an ASIC).

The above-described process can be changed as appropriate, such as by changing the order. For example, in the ink ejection amount upper limit value determination process shown in FIG. 8, the process of S102 may be performed immediately after the process of S104.

In the above-described processes, for example, the determination of “greater than or equal to” can be replaced with the determination of “greater than”, and the determination of “less than” can be replaced with the determination of “less than or equal to”. The present includes replacing the judgment in these ways.

The reading section that reads at least a part of the plurality of patches included in the test pattern 500 is not limited to the imaging section 261, and may be an image reading section such as a scanner.

It should be noted that the control section 110 may determine the ejection amount upper limit value Dt_final only for the primary color. In this case, the control section 110 may treat the ejection amount upper limit value of the secondary color as, for example, twice the ejection amount upper limit value Dt_final of the primary color, or may treat the ejection amount upper limit value of the tertiary color as, for example, three times the ejection amount upper limit value Dt_final of the primary color.

### (6) Conclusions

As described above, according to various aspects of the present disclosure, it is possible to provide, for example, a technique capable of determining an ejection amount upper limit value at which an excessive decrease in coloration property or excessive bleeding of a liquid is suppressed, even if a variation in bleeding is large. Of course, the above-described basic operations and effects can be obtained even with a technology consisting only of the constituent elements according to the independent claims.

A configuration in which the respective configurations disclosed in the above-described examples are replaced with each other or combinations thereof are changed, a configuration in which the respective configurations disclosed in the well-known art and the above-described examples are replaced with each other or combinations thereof are changed, and the like can also be implemented. The present disclosure also includes these configurations.

What is claimed is:

1. An ejection amount upper limit value determination method for determining, with respect to a liquid ejected from a print head to a medium, an upper limit value of a per unit area ejection amount with allowable liquid bleeding,
the liquid including a plurality of different color types,
the ejection amount upper limit value determination method comprising:
a test pattern formation step of forming, on the medium, a test pattern including a plurality of pattern arrays, the pattern arrays including a plurality of patches having different ejection amounts and each patch including a bleeding detection region and a background region having a color different from that of the bleeding detection region and
an upper limit value determination step of acquiring reading results of the plurality of patches included in the pattern arrays and determining the upper limit value based on the reading results of the plurality of patches, wherein
in the upper limit value determination step,
a provisional ejection amount upper limit value, which is a provisional value of the upper limit value, is determined for each of the pattern arrays based on reading results of the plurality of patches included in the pattern arrays,
when a difference between a maximum value of the plurality of the provisional ejection amount upper limit values obtained for the plurality of pattern arrays and a minimum value of the plurality of the provisional ejection amount upper limit values is within an allowable range, one of the minimum value and the maximum value is determined as the upper limit value, and
when the difference exceeds the allowable range, the upper limit value is determined to be greater than the minimum value and also less than the maximum value.

2. The ejection amount upper limit value determination method according to claim 1, wherein
in the upper limit value determination step, if the difference exceeds the allowable range, the mean of the multiple provisional ejection amount upper limit values is determined as the upper limit value.

3. The ejection amount upper limit value determination method according to claim 1, wherein
the test pattern includes an n-th color test pattern wherein the bleeding detection region of the patch is of an n-th color, where n is an integer that is 1 or more and also that is less than the number of types of the liquid,
the provisional ejection amount upper limit value includes an n-th color provisional ejection amount upper limit value for the n-th color test pattern,
the allowable range includes an n-th color allowable range for the n-th color, and
in the upper limit value determination step,
an n-th color provisional ejection amount upper limit value is determined for each of the pattern arrays in the n-th color test pattern based on reading results of the plurality of patches included in the pattern arrays,
when the difference between an n-th color maximum value, which is the maximum value of a plurality of n-th color provisional ejection amount upper limit values, and an n-th color minimum value, which is the minimum value of the plurality of n-th color provisional ejection amount upper limit values, is within the n-th color allowable range, then one of n-th color minimum value and the n-th color maximum value is determined to be the upper limit value for the n-th color, and
when the difference between the n-th color maximum value and the n-th color minimum value exceeds the n-th color allowable range, the upper limit value for the n-th color is determined so as to be larger than the n-th color minimum value and also smaller than the n-th color maximum value.

4. The ejection amount upper limit value determination method according to claim 1, wherein
the test pattern includes an individual color test pattern of an individual color, which is included in a plurality of colors in which the bleeding detection region of the patch is an n-th color, where n is an integer that is 1 or more and also that is less than the number of types of the liquid,
the provisional ejection amount upper limit value includes an individual color provisional ejection amount upper limit value for the individual color test pattern,
the allowable range includes an individual color allowable range for the individual color, and
in the upper limit value determination step,
for each of the pattern arrays in the individual color test pattern, the individual color provisional ejection amount upper limit value is determined based on the reading results of the plurality of patches included in the pattern arrays,
when a difference between an individual color maximum value, which is a maximum value of the plurality of individual color provisional ejection amount upper limit values, and an individual color minimum value, which is a minimum value of the plurality of individual color provisional ejection amount upper limit values, is within the individual color allowable range, one of the individual color minimum value and the individual color maximum value is determined as the upper limit value for the individual color, and
when the difference between the individual color maximum value and the individual color minimum value exceeds the individual color allowable range, the upper limit value for the individual color is determined so as to be larger than the individual color minimum value and also smaller than the individual color maximum value.

5. The ejection amount upper limit value determination method according to claim 1, further comprising:
an allowable range update reception step for receiving an operation to update the allowable range and updating the allowable range in response to the operation.

6. The ejection amount upper limit value determination method according to claim 1, wherein
in the upper limit value determination step, for each of the pattern arrays, a bleeding amount representing the degree of bleeding of the bleeding detection region included in each of the patches is acquired from the reading results of the plurality of patches included in the pattern array, and the provisional ejection amount upper limit value is determined by comparing a determination threshold value corresponding to the upper limit of the bleeding amount and each of the bleeding amounts and
the ejection amount upper limit value determination method further comprises a determination threshold value change reception step for receiving a change of the determination threshold value.

7. The ejection amount upper limit value determination method according to claim 1, wherein
in the upper limit value determination step, the minimum value is determined to be the upper limit value when the difference is within the allowable range.

8. A printing device comprising:
a print head that ejects a plurality of types of liquids having different colors onto a medium;
a control section configured to control the formation of a test pattern on the medium, the test pattern including a plurality of pattern arrays, the pattern arrays each including a plurality of patches having different per unit area ejection amounts with allowable liquid bleeding for the liquid, each patch of the pattern arrays including a bleeding detection region and a background region having a color different from that of the bleeding detection region, to acquire reading results of the plurality of patches included in the plurality of pattern arrays, and to determine an upper limit value of the ejection amount based on the reading results of the plurality of patches; and
a reading section that reads the plurality of patches, wherein
the control section performs
a first process of determining a provisional ejection amount upper limit value, which is a provisional value of the upper limit value, for each of the pattern arrays based on reading results of the plurality of patches included in the pattern arrays,
a second process of, when a difference between a maximum value of the plurality of provisional ejection amount upper limit values obtained for the plurality of pattern arrays and a minimum value of the plurality of provisional ejection amount upper limit values is within an allowable range, determining one of the minimum value and the maximum value as the upper limit value, and
a third process of, when the difference exceeds the allowable range, determining the upper limit value so as to be larger than the minimum value and also smaller than the maximum value.
